(19) United States
(12) Patent Application Publication
(10) Pub. No.: US 2026/0155984 A1
(43) Pub. Date: Jun. 4, 2026

(54) VIDEO SIGNATURE LIVE CONTRACT SYSTEM AND METHOD

(71) Applicant: E.FORM WORKS CO., LTD., Seoul (KR)

(72) Inventor: Je Hoon YU, Seoul (KR)

(21) Appl. No.: 19/115,687

(22) PCT Filed: Sep. 27, 2022
(86) PCT No.: PCT/KR2022/014456

§ 371 Date: Mar. 26, 2025

(51) Int. Cl. H04L 9/32; G06F 40/186; G06V 20/00; G06V 20/40; G06V 40/16; G06V 40/70; G10L 15/30; G10L 25/57

(52) U.S. Cl. CPC H04L 9/3234; G06F 40/186; G06V 20/40; G06V 20/95; G06V 40/172; G06V 40/70; H04L 9/3231; G06V 2201/10; G10L 15/30; G10L 25/57

(57) ABSTRACT

The present disclosure relates to a video signature live contract system and a method thereof, wherein the video signature live contract system includes an identity verification unit that receives an ID card image from a user terminal and verifies authenticity of the ID card; a contract management unit that provides a real-time video contract screen on the user terminal and records the real-time video contract process; a video signature generation unit that generates a video signature using the video captured by the user terminal and signature data received from the user terminal; and a face ID generation unit that generates a face ID using the video captured by the user terminal during the video signature generation process, issues a non-fungible token for the generated face ID, and stores and manages the non-fungible token on a blockchain, wherein the video signature includes both the video captured by the user terminal and a visual representation of the signature data generation process.

### TECHNICAL FIELD

The present disclosure relates to a video signature live contract system and a method thereof.

### BACKGROUND ART

Recently, due to the impact of COVID-19, business processing in a non-contact work environment, for example, video conferencing and telecommuting, has become a prevailing trend.

The revision of the Electronic Signature Act has abolished the superior status of accredited certificates and created a need for an alternative authentication method that is as strong as the accredited certificate. Accordingly, to fully replace offline signatures with online signatures, it has become increasingly important to have a technical means for verifying the identity of the signing party.

To deal with the situation, private certificates may be used for authentication and signing; however, they are insufficient to completely alleviate concerns of the signing party. For example, when an electronic document is used for signing a contract, and each signing party remotely applies an electronic signature using their user terminal, the signing party has to rely on the reliability of technical means for the electronic signature, making it difficult for the signing party to directly experience the trustworthiness of the electronic document and electronic signature.

### DISCLOSURE

### Technical Problem

The present disclosure aims to provide a video signature live contract system and a method of the system, which may prevent spoofing that may occur in a remote contract process, prevent repudiation by contract participants, and ensure the reliability and security of the contract by recording the real-time video contract process and providing a video signature function and a function of encrypting video signatures and generating a face ID at the time of video signing.

Technical objects to be achieved by the present disclosure are not limited to those described above, and other technical objects not mentioned above may also be clearly understood from the descriptions given below by those skilled in the art to which the present disclosure belongs.

### Technical Solution

A video signature live contract system according to one embodiment of the present disclosure may comprise an identity verification unit that receives an ID card image from a user terminal and verifies the authenticity of the ID card; a contract management unit that provides a real-time video contract screen on the user terminal and records the real-time video contract process; a video signature generation unit that generates a video signature using the video captured by the user terminal and signature data received from the user terminal; and a face ID generation unit that creates a face ID using the video captured by the user terminal during the video signature generation process, issues a non-fungible token for the generated face ID, and stores and manages the non-fungible token on a blockchain, wherein the video signature includes both the video captured by the user terminal and a visual representation of the signature data generation process.

The video signature generation unit may display signature information that includes the name of a signing participant who generates the signature data and the completion time point of a signature on the video signature screen, wherein the video signature generation unit may generate a video signature ID which serves as identification information for the video signature.

The video signature generation unit, being linked with the user terminal to perform encryption and decryption processes for the signature data, may receive a signature key required for decryption from the user terminal and generate video signature information for the video signature, wherein the video signature information may include a contract name of the real-time video contract, date of the signature data generation, and the signature key.

The system may further include a media conversion unit that converts and stores a contract generated during a real-time video contract process into a document file and issues a document ID as the identification information of the contract, wherein the document ID is stored by being mapped to the video signature ID and the face ID generated during the corresponding real-time video contract process.

The media conversion unit may generate an identification code for the contract and write the code into the document file, wherein the identification code is the data obtained by encrypting the document ID, the video signature ID, and the face ID.

The face ID generation unit may store metadata for the non-fungible token of the face ID, wherein the metadata includes the video signature ID, the document ID, and user information of a user who owns the user terminal.

The contract management unit may include a log generation module that generates and manages log data for activities of the user terminal during the real-time video contract process and a speech-to-text (STT) module that analyzes voice data received from the user terminal during the real-time video contract process and converts the analyzed voice data into text data.

A video signature live contract method according to one embodiment of the present disclosure, in which a system provides real-time video contract and video signature services to a plurality of user terminals, comprises performing user authentication in response to a request from a first user terminal held by a contract participant among the plurality of user terminals by the system, sending an invitation link to a second user terminal different from the first user terminal in response to a request from the first user terminal by the system, providing a real-time video contract screen to the plurality of user terminals by the system, providing a video signature function to at least one of the plurality of user terminals by the system, and generating a video signature and a face ID for a contract participant carrying the at least one user terminal by the system, wherein the system generates a video signature using a video captured by the at least one user terminal and signature data received from the at least one user terminal, and the system analyzes a user's face included in a video captured by the user terminal and generates a face ID.

The generating of the video signature by the system may include displaying signature information, which includes the name of a signing participant who has generated the signature data and a signature completion time point, on the video signature screen and generating a video signature ID, which serves as identification information for the video signature.

The method may further include receiving a plurality of data, including signature data, from each of the plurality of user terminals and writing a contract by the system; converting and storing the contract generated during the real-time video contract process into a document file and issuing a document ID by the system, which serves as identification information of the contract; and storing the document ID by mapping the document ID to the video signature ID and the face ID generated during the real-time video contract process by the system.

The method may further include issuing a non-fungible token for the face ID and storing and managing the token on a blockchain by the system and storing metadata related to the non-fungible token of the face ID by the system, wherein the metadata includes the video signature ID, the document ID, and user information of the user terminal in which the face ID has been generated.

The providing of the real-time video contract screen to the plurality of user terminals by the system may include providing a contract template to the plurality of user terminals by the system and displaying a list of a plurality of contract participants along with input fields designated for each participant by the system.

The method may further include generating and managing log data for activities of each of the plurality of user terminals during the real-time video contract process by the system and analyzing voice data received from each of the plurality of user terminals during the real-time video contract process and converting the analyzed voice data into text data by the system.

The method may further include recording a real-time video contract process for the plurality of user terminals, generating video contract data, and providing the video contract data to the at least one of the user terminals by the system.

The providing of the video contract data to the at least one of the user terminals by the system may include receiving identity verification data and an identification code from the at least one of the user terminals by the system and verifying whether the received identity verification data corresponds to the identification code.

Specific details of other embodiments are included in the detailed description and appended drawings.

### Advantageous Effects

According to a video signature live contract system and a method of the system according to embodiments of the present disclosure, by recording a real-time video contract process and providing a video signature function and a function of encrypting video signatures and generating a face ID at the time of video signing, spoofing that may occur in a remote contract process may be prevented, and repudiation by contract participants may be further prevented; therefore, reliability and security of a contract may be enhanced compared not only to a remote contract using conventional electronic documents and electronic signatures but also to a face-to-face contract.

Also, since video signatures, face IDs, and documents generated during a real-time video contract process may be separately encrypted and/or managed on a blockchain, it may be advantageous in that forgery or tampering of a contract document is prevented, and contract security is enhanced.

The effects according to the embodiments of the present disclosure are not limited to the description above, and various other effects are included within the present document.

### DESCRIPTION OF DRAWINGS

FIG. 1 illustrates the network structure of a video signature live contract system according to one embodiment of the present disclosure.

FIG. 2 is a block diagram illustrating the structure of a user terminal according to one embodiment of the present disclosure.

FIG. 3 is a block diagram illustrating the structure of a video signature live contract system according to one embodiment of the present disclosure.

FIG. 4 is a block diagram illustrating the structure of a contract management unit according to one embodiment of the present disclosure.

FIG. 5 is a flow diagram illustrating a video signature live contract method of a video signature live contract system according to one embodiment of the present disclosure.

FIG. 6 is a flow diagram illustrating a real-time video contract process of a video signature live contract system and a video signature service provision method according to one embodiment of the present disclosure.

FIG. 7 is a flow diagram illustrating a method for providing a video contract data to a user terminal by a video signature live contract system according to one embodiment of the present disclosure.

FIGS. 8 to 12 are screen examples provided to a user terminal by a video signature live contract system through an application program, an app, and/or a website according to one embodiment of the present disclosure.

FIG. 8 shows a screen in which a video signature live contract system provides a participant invitation function to a user terminal according to one embodiment of the present disclosure.

FIG. 9 shows a screen in which a video signature live contract system provides a real-time video contract service to a user terminal according to one embodiment of the present disclosure.

FIG. 10 shows a screen in which a video signature live contract system generates and manages log data for a real-time video contract according to one embodiment of the present disclosure.

FIG. 11 shows a screen in which a video signature live contract system converts a contract generated during a real-time video contract process into a document form according to one embodiment of the present disclosure.

FIG. 12 is an enlarged view of area A in FIG. 11, illustrating a screen in which a video signature live contract system provides video signature data to a user terminal according to one embodiment of the present disclosure.

### MODE FOR DISCLOSURE

In what follows, preferred embodiments of the present disclosure will be described in detail with reference to appended drawings to clarify the technical principles of the present disclosure. In describing the present disclosure, if it is determined that a detailed description of known functions or constituting elements incorporated herein unnecessarily obscure the gist of the present disclosure, the detailed description thereof will be omitted. For those constituting elements that have actually the same functional configuration across the drawings, the same reference numbers and symbols have been assigned whenever possible, even if they appear in different drawings. For the convenience of description, a device and a method may be described together when necessary.

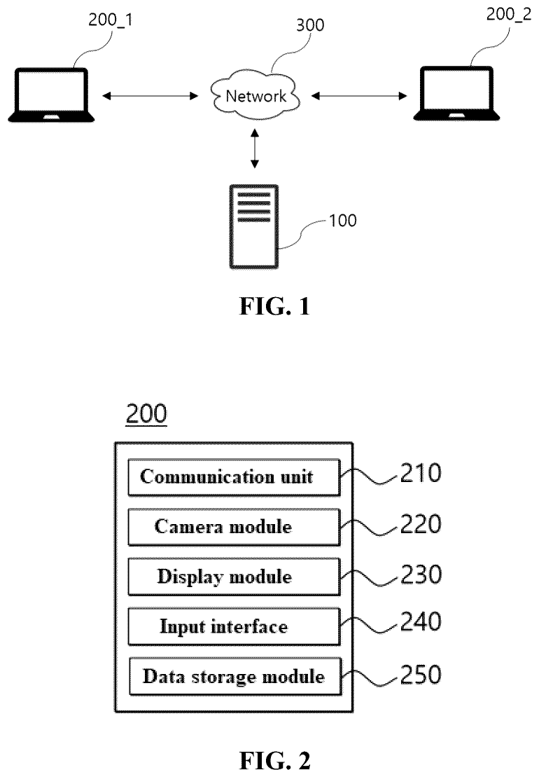

FIG. 1 illustrates the network structure of a video signature live contract system according to one embodiment of the present disclosure.

Referring to FIG. 1, the network configuration of the video signature live contract system according to one embodiment may include a video signature live contract system 100, a plurality of user terminals 200_1, 200_2, and a network 300.

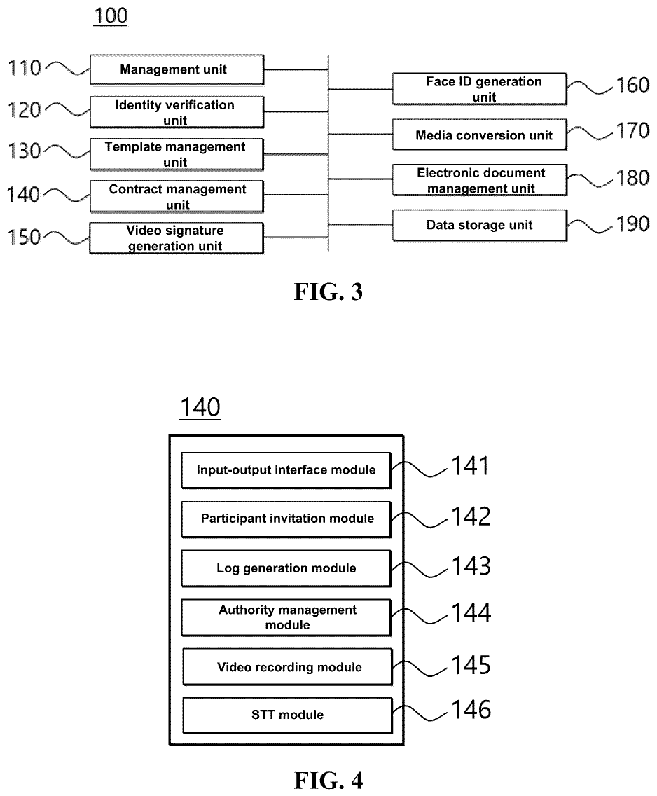

The video signature live contract system 100 (in what follows, referred to as “system 100”) may provide an application program, an app, and/or a website to the user terminal 200 and provide a video signature live contract service so that the user terminal 200 may perform a real-time video contract and a video signature through the provided application program, app, and/or website. A detailed description of the video signature live contract system 100 will be provided with reference to FIGS. 3 and 4.

Each of the plurality of user terminals 200_1, 200_2 may be an electronic device held by a user utilizing services provided by the video signature live contract system 100. For example, the user terminal 200 may include a mobile phone, a smartphone, a smart pad, a notebook computer, a digital broadcasting terminal, a Personal Digital Assistant (PDA), a Portable Multimedia Player (PMP), a navigation device, a tablet PC, and various wearable devices such as a smart watch and a smart band. However, the user terminal is not limited to the specific examples and may include any electronic device capable of playing a video, equipped with a communication function supporting wireless communication, a camera function, and an input function.

The user terminal 200 may install and run the application program and/or app provided by the video signature live contract system 100 or access a website provided by the video signature live contract system 100 through the network 300. The user terminal 200 may utilize the video signature live contract services provided by the video signature live contract system 100 through the application program, app, and/or website.

FIG. 2 is a block diagram illustrating the structure of a user terminal according to one embodiment of the present disclosure.

Referring to FIG. 2, the user terminal 200 may include a communication unit 210, a camera module 220, a display module 230, an input interface 240, and a data storage module 250.

The communication unit 210 may perform data communication with the video signature live contract system 100 via wired or wireless communication. The communication unit 210 may transmit and receive data to and from the video signature live contract system 100 and other user terminals 200 using a wired Internet communication method supporting Transmission Control Protocol/Internet Protocol (TCP/IP) or at least one of various wireless communication methods including Wideband Code Division Multiple Access (WCDMA), Long Term Evolution (LTE), Wireless Broadband Internet (WiBro), and Wireless Fidelity (WiFi).

The camera module 220 may be embedded in the user terminal 200, but the present disclosure is not limited to the specific implementation. As another example, the camera module 220 may be implemented in the form of a webcam and may be connected to the user terminal 200 via a wired or wireless connection. The user terminal 200 may provide a real-time video captured through the camera module 220 to the video signature live contract system 100.

The display module 230 may display the screen provided by the video signature live contract system 100 on the user terminal 200. Also, in some embodiments, the display module 230 may include a touch screen panel (TSP); in this case, the display module 230 may also function as an input interface 240.

The input interface 240 may interact with input devices such as a keyboard, a mouse, a touch pen, or a touchpad to convert the user input into data. The user terminal 200 may provide the data received through the input interface 240 to the video signature live contract system 100. For example, if a user performs signing using the display module 230, which includes a touch screen panel, the input interface 240 may provide the corresponding signature data to the video signature live contract system 100.

The data storage module 250 may store data received from the video signature live contract system 100 and other user terminals 200 via the network 300. For example, the data storage module 250 may store a copy of the contract received from the video signature live contract system 100.

The network 300 is a communication network that enables communication between the video signature live contract system 100 and a plurality of user terminals 200 and may be configured regardless of the communication type. For example, the network 300 may be constructed using various types of communication networks, such as a personal area network (PAN), local area network (LAN), metropolitan area network (MAN), or wide area network (WAN) but is not limited thereto.

FIG. 3 is a block diagram illustrating the structure of a video signature live contract system according to one embodiment of the present disclosure.

Referring to FIG. 3, the video signature live contract system 100 according to one embodiment may include a management unit 110, an identity verification unit 120, a template management unit 130, a contract management unit 140, a video signature generation unit 150, a face ID generation unit 160, a media conversion unit 170, an electronic document management unit 180, and a data storage unit 190.

The management unit 110 may communicate data via wired or wireless connection with a plurality of user terminals 200_1, 200_2 through the network 300. For example, the management unit 110 may provide an application program and/or an app to the user terminal 200 and exchange data with the user terminal 200 running the provided application program and/or app; however, the present disclosure is not limited to the specific description. The management unit 110 may also provide a website to the user terminal 200 and exchange data through the website.

The management unit 110 may control the overall operation of the components of the video signature live contract system 100. When the video signature live contract system 100 provides video signature live contract services to a plurality of user terminals 200, the management unit 110 may manage and control the operation of each component.

As a specific example, when a user terminal 200 scans the identification code disposed on a contract copy generated by the system 100 and accesses the application program, app, and/or website provided by the video signature live contract system 100, the management unit 110 may request identity verification data from the user terminal 200; upon receiving the identity verification data from the user terminal 200, the management unit 110 may provide the identity verification data to the identity verification unit 120 and request verification of whether the user corresponds to the identification code.

Also, the management unit 110 may request the user terminal 200 to complete a membership registration process to access the video signature live contract service. In this case, the management unit 110 may store user information, including the user ID and password registered during the membership registration process, in the data storage unit 190. However, the present disclosure is not limited to the specific case.

For example, the video signature live contract system 100 may provide video signature live contract services without a separate membership registration process; instead, the system 100 may store ID card data received from the user terminal 200 when the video signature live contract service is provided and/or user identity verification data (e.g., face ID) generated while the video signature live contract service is provided.

In this case, when the user terminal 200 accesses the application program, app, and/or website provided by the video signature live contract system 100, the management unit 110 may request the ID card data and/or user identity verification data from the user terminal 200. Here, the ID card data may be the data obtained by extracting an ID card image received from the user terminal 200 using optical character recognition (OCR).

The identity verification unit 120, upon receiving an ID card image from the user terminal 200, may verify the authenticity of the corresponding ID card in conjunction with an external ID card authentication application programming interface (API).

In this case, the identity verification unit 120 may extract data from the ID card image using optical character recognition and use the extracted data to verify the authenticity of the corresponding ID card through the external ID card authentication API; however, the present disclosure is not limited to the specific description. In some embodiments, the identity verification unit 120 may verify the authenticity of the corresponding ID card through the external ID card authentication API using the ID card image.

In another embodiment, the identity verification unit 120 may develop its own ID card authentication API to verify the authenticity of the ID card.

The identity verification unit 120 may perform user authentication based on the data received from the user terminal 200. For example, the identity verification unit 120 may verify whether the data received from the user terminal 200 matches the information (e.g., the contract participant's user ID and password and/or user terminal information) of a user who uses the corresponding user terminal 200.

Also, the identity verification unit 120 may verify whether the identity verification data received from the user terminal 200 matches pre-stored identity verification data. For example, in response to a request from the management unit 110, the identity verification unit 120 may check whether the identity verification data received from the user terminal 200 matches pre-stored identity verification data. The pre-stored identity verification data may include a face ID generated by the face ID generation unit 160, for which a non-fungible token (NFT) has been issued. Also, the pre-stored identity verification data may include the user ID and password registered by the user terminal 200 during the membership registration process for accessing the services provided by the system 100.

The template management unit 130 may store and manage various types of contract templates. For example, the template management unit 130 may store and manage standard contracts for various contracts, such as employment contracts, lease agreements, rental agreements, subcontracts, agency agreements, and partnership agreements.

The template management unit 130 may classify and assign input fields for each contract participant within the respective contracts. For example, each contract may include a plurality of input fields that contract participants need to complete, and the template management unit 130 may classify and designate required input fields for each contract participant during the contract process.

In the present disclosure, contract participants may be classified as the contract initiator (or master), signing participants with signing authority, observers, assignees with delegated contract authority, and notaries, but they are not limited to the specific description above. Also, the initiator may be any one of the plurality of signing participants.

The template management unit 130 may distinguish and display a plurality of input fields in a contract document during the contract process according to the input fields relevant to the role of each contract participant. For example, when the video signature live contract system 100 displays a contract on each user terminal 200, the template management unit 130 may display input fields assigned in response to each contract participant, who uses their own user terminal 200, differently from other input fields.

Specifically, the template management unit 130 may highlight the input fields assigned for a contract participant using a different color from those used for other input fields and/or emphasize the input fields using a box user interface (UI), but the present disclosure is not limited to the specific example. In some embodiments, the template management unit 130 may configure the user terminal 200 so that other input fields except for the input fields assigned to a specific contract participant may not be modified through the user terminal 200 of the corresponding contract participant.

Also, the template management unit 130 may generate a list of a plurality of contract participants on one side of the contract document displayed on the user terminal 200 and display both the number of input fields assigned to each contract participant and the number of completed input fields. In this case, if the user terminal 200 selects a contract participant from the list, the template management unit 130 may provide a function that navigates to the input fields assigned to the corresponding contract participant.

The template management unit 130 may provide a contract generation and editing function to the user terminal 200. The template management unit 130 may provide a plurality of standard contract templates while also providing the user terminal 200 with a function for editing the plurality of standard contract templates or a function for generating a new contract.

The template management unit 130 may automatically classify and assign input fields for each contract participant from a generated or edited contract. However, the present disclosure is not limited to the specific description; for example, during the contract generation and editing process, the template management unit 130 may receive classification data of input fields for each contract participant from the user terminal 200 and accordingly classify and assign the input fields for each contract participant.

If any contract participant delegates authority to another person through the authority management module 144, which will be described later, the template management unit 130 may reassign the input fields originally designated for the delegating contract participant to the assignee contract participant.

In this manner, the template management unit 130 according to one embodiment may improve integrity and reliability of a contract by providing a plurality of standard contract templates and a function of generating and editing a contract along with a function that facilitates a real-time video contract by classifying and assigning input fields for each contract participant and allows checking which participant has completed which input field when a finalized contract is reviewed at a later time.

When a user terminal 200 accesses an application program, an app, and/or a website provided by the system 100, the template management unit 130 may provide the user terminal 200 with a list of previously conducted contracts and/or a list of contract templates pre-generated by the user terminal 200. Here, the list of previously conducted contracts may include real-time video contracts conducted by the user terminal 200 but saved in a state where video recording was paused during the contract process. The list of pre-generated templates may include contract documents generated by the user terminal 200 through the template management unit 130 before a real-time video contract is conducted.

Also, if the user terminal 200 invites at least one contract participant through the participant invitation module 142, the template management unit 130 may check whether there is any previously conducted contract between the user carrying the user terminal 200 and the invited contract participant. If a previously conducted contract exists, the template management unit 130 may provide the contract template corresponding to the previously conducted contract to the user terminal 200.

The contract management unit 140 may control and manage real-time video contracts. The contract management unit 140 may transmit and receive data to and from the user terminal 200 of each of a plurality of contract participants to write a contract. Also, the contract management unit 140 may forward data received from the user terminal 200 to the video signature generation unit 150 and the face ID generation unit 160 or link the video signature and face ID generated by the video signature generation unit 150 and the face ID generation unit 160 to the contract being written.

Referring to FIG. 4, the contract management unit 140 according to an embodiment may include an input-output interface module 141, a participant invitation module 142, a log generation module 143, an authority management module 144, a video recording module 145, and a speech-to-text (STT) module 146.

The input-output interface module 141 may interact with a plurality of user terminals 200 through an application program, an app, and/or a website provided by the system 100. The input-output interface module 141 may output data such as a real-time video contract screen to a plurality of user terminals 200 or receive data from the plurality of user terminals 200.

The real-time video contract screen provided by the input-output interface module 141 to the user terminal 200 may include a plurality of user interfaces (UI). When the user terminal 200 selects (or clicks) one of the plurality of user interfaces, the input-output interface module 141 may provide a screen corresponding to the selected user interface, transmit data to a different part of the system 100, or request the different part to perform the related function.

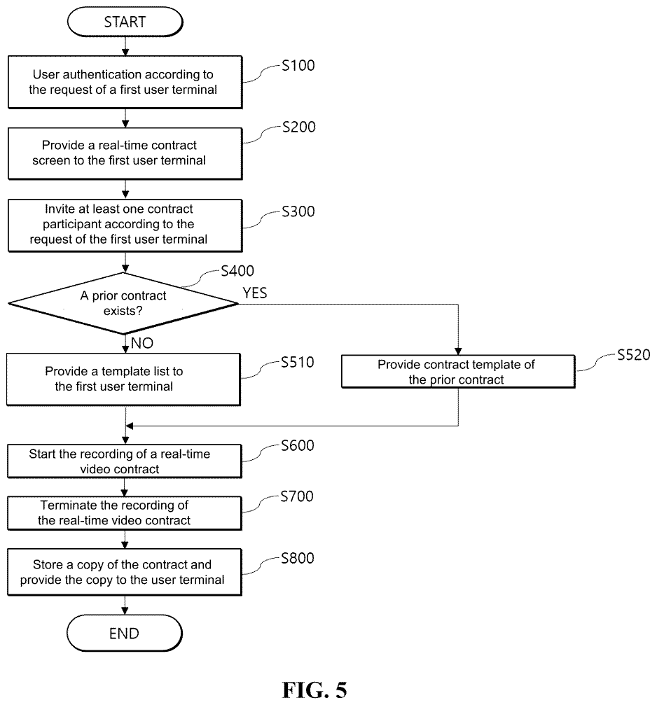

For example, if a particular user terminal 200 attaches an ID card image during the contract process, the input-output interface module 141 may provide the ID card image to the identity verification unit 120. Specific examples of the real-time video contract screen provided by the input-output interface module 141 to the user terminal 200 will be described later with reference to FIGS. 5 to 12.

The participant invitation module 142 may provide a contract participant invitation function to the user terminal 200. For example, in response to a request from the user terminal 200, the participant invitation module 142 may send an invitation link for the participation in the video signature live contract to another user terminal 200. When providing the invitation link to the invited user terminal 200, the participant invitation module 142 may additionally provide information such as the inviter, contract-related details (e.g., contract name), and the contract participant type (e.g., signing participant, observer, assignee, or notary), but the present disclosure is not limited to the description above.

Here, the invitation link may be a link that allows the invited user terminal 200 to access the generated contract through the application program, app, and/or website provided by the system 100. The invitation link may be provided in various forms, such as an icon or text.

To provide a contract participant invitation function to the user terminal 200, the participant invitation module 142 may operate in conjunction with a contacts, email, and/or messenger application of the user terminal 200 through the input-output interface module 141.

The participant invitation module 142 may send an email containing the invitation link to an email account of the invited contract participant, send a short message service (SMS) message containing the invitation link to the user terminal 200 of the invited contract participant, and/or send a message containing the invitation link via the messenger application.

Also, if an application program or an app provided by the video signature live contract system 100 is installed in the user terminal 200 of the invited contract participant, the participant invitation module 142 may send a notification popup containing the invitation link to the user terminal 200 of the contract participant.

The log generation module 143 may generate and manage log data for the real-time video contract process, such as the start (e.g., initiation of video recording), pause, and completion of a real-time video contract, and activity records of each user terminal 200.

Here, the activity records of each of a plurality of user terminals 200 may include the time of invitation, time of participation, time of information input in the input fields assigned to each participant, start and completion time of a video signature, delegation of authority, approval of delegation, and time of acceptance for each of the plurality of user terminals 200. However, the present disclosure is not limited to the specific example, and the activity records may represent the interactions between the plurality of user terminals 200 and the system 100 during the real-time video contract process.

The log generation module 143 may list the sequence of events in a real-time video contract process in chronological order and provide the ordered sequence in real-time to the plurality of user terminals 200. Also, when the real-time video contract is completed, the log generation module 143 may manage and store a plurality of log data generated during the real-time video contract process so that the log data are linked with a recorded video and/or the corresponding contract document.

The authority management module 144 may provide a function for delegating authority of a contract participant to the user terminal 200. For example, a contract participant may delegate their contract authority through the authority management module 144. Here, the contract authority may include the right of a contract participant to sign during a real-time video contract and the right of the contract participant to enter data into input fields assigned to the contract participant through the system 100, but the contract authority is not limited to the specific example above.

When receiving a delegation request from the user terminal 200 through the input-output interface module 141, the authority management module 144 may provide a power of attorney form to the requesting user terminal 200. For example, the authority management module 144 may display the power of attorney form in a popup window on the user terminal 200 through the input-output interface module 141, but the present disclosure is not limited to the specific example and may provide the power of attorney form in various other forms.

The power of attorney form may include information on the delegator, such as the contract name and the delegator's signature and contact details, wherein the delegator's signature and information of an appointed representative may be provided through designated input fields. The information on the appointed representative may include, but is not limited to, its name, relationship with the delegator, email address, phone number, and ID card image.

When the user terminal 200 attaches an ID card image of the appointed representative to the power of attorney form, the authority management module 144 may provide the ID card image of the appointed representative to the identity verification unit 120 and request verification of its authenticity.

If receiving a request from the user terminal 200 for the delegator's signature on the power of attorney form (e.g., when the user clicks the signature field of the power of attorney on the user terminal 200), the authority management module 144 may provide an additional signature popup window for signing through the user terminal 200. In this case, the delegator may proceed with a video signature via the user terminal 200, but the present disclosure is not limited to the description above. In some embodiments, the delegator may sign using the user terminal 200 with an electronic handwritten signature (or a drawing-based signature) or authenticate the signature using a public certificate or a private certificate (e.g., KakaoPay authentication, PASS app authentication, or BankSign).

The authority management module 144 may send a delegation approval request to the user terminals 200 of contract participants other than the delegator who has delegated the contract authority. For example, once the delegator completes the power of attorney form, the authority management module 144 may send a delegation approval request to the user terminals 200 of signing participants and the contract initiator, excluding the delegator. The delegation approval request may be provided as a notification popup on the user terminals 200 of the signing participants and the contract initiator, excluding the delegator, but the present disclosure is not limited to the description above.

The authority management module 144 may send a contract invitation request for the assignee to the participant invitation module 142. For example, the authority management module 144 may transmit the phone number or email address entered in the power of attorney form, along with the contract invitation request, to the participant invitation module 142. Accordingly, the participant invitation module 142 may send an email, a message, and/or a notification popup containing the invitation link to the user terminal 200 of the assignee. In this case, the participant invitation module 142 may provide authority delegation information to the assignee's user terminal 200 along with the invitation link. The authority delegation information may include the name of a contract delegated by the delegator, delegated authority, and the delegation date.

In some embodiments, the authority management module 144 may classify the delegator, who has delegated their contract authority, as an observer, but the present disclosure is not limited to the specific embodiment. Also, the authority management module 144 may grant or revoke contract authority for contract participants at the request from the user terminal 200 of the contract initiator.

In this manner, by providing a contract authority delegation function within the system 100 for remote contracts and storing and managing authority delegation information, the authority management module 144 according to one embodiment streamlines the otherwise cumbersome delegation verification process among contract participants and facilitates subsequent verification of whether the delegation has been legally executed.

The video recording module 145 may record a real-time video contract process in conjunction with the input-output interface module 141. The video recording module 145 may start, pause, and stop video recording at the request of the contract initiator's user terminal 200. The video recording module 145 may record the video recording duration, excluding video recording pause periods. The video recording module 145 may store the recorded video contract data, which contains recordings of the real-time video contract process, in the data storage unit 190. In this case, the video contract data may be stored by being mapped to a document ID to be described later and a video signature ID and a Face ID, which are generated during the contract process.

The speech-to-text (STT) module 146 may operate in conjunction with the input-output interface module 141 to receive voice data from a plurality of contract participants through a plurality of user terminals 200 during the real-time video contract process, analyze the voice data, and convert the analyzed voice data into text data. The STT module 146 may distinguish the voice data of each of the plurality of contract participants and convert the voice data separately into text data.

The STT module 146 may display the converted text data in synchronization with the recorded contract video by operating in conjunction with the video recording module 145. In this case, the converted text data may be displayed on the recorded contract video, but the present disclosure is not limited to the specific example. Alternatively, the converted text data may be provided as a separate recorded video alongside the recorded contract video.

Also, the STT module 146 may generate a document file containing the converted text data and display the converted text data along with the corresponding timestamps indicating the time points at which the voice data is received from the plurality of user terminals 200.

As described above, the STT module 146 according to one embodiment converts voice data generated by a plurality of signing participants during a real-time video contract process into text data and displays the converted text data in synchronization with a recorded contract video, which allows participants to conveniently review the convenience during the video contract process even when the audio is not heard. Also, by generating a document file containing the converted text data, the STT module 146 eliminates the need to review conversations during the contract process through a recorded video, providing the advantage that the document file may serve as a transcript in case of any future disputes.

Referring back to FIG. 3, the video signature generation unit 150 may generate a video signature in conjunction with the contract management unit 140. For example, if a signing participant with contract signing authority requests generation of a video signature during a real-time video contract via the user terminal 200, the video signature generation unit 150 may generate a video signature using a plurality of data received from the user terminal 200 through the input-output interface module 141. Here, the request for generation of a video signature from the user terminal 200 may be triggered when the user selects a user interface (UI) provided on the screen displayed through the display module 230 of the user terminal 200, but the present disclosure is not limited thereto.

The video signature generation unit 150 may receive a video captured by the camera module 220 of the user terminal 200 from the input-output interface module 141 and record the captured video. Also, the video signature generation unit 150 may provide a signature popup window on the user terminal 200 through the input-output interface module 141. The signing participant may input an electronic handwritten signature or a stamp image into the signature popup window using their user terminal 200, or authenticate the signature using a public certificate or a private certificate (e.g., KakaoPay authentication, PASS app authentication, or BankSign).

When the user terminal 200 performs signing through the signature popup window, the video signature generation unit 150 may receive the signing process in real-time through the input-output interface module 141 and record the signing process so that it is displayed on a video signature screen. Also, when the user terminal 200 completes inputting of signature data in the popup window, the video signature generation unit 150 may display signature information on the video signature screen, including the name of the signing participant and the time point at which the signing is completed.

When the user terminal 200 performs signing through the popup window, the video signature generation unit 150 may execute signature encryption and decryption processes in conjunction with the user terminal 200 to ensure the security and reliability of the corresponding signature.

For example, the video signature generation unit 150 may receive a public key, which is a pair to the private key used for electronic signing, from the user terminal 200 and verify the electronic signature using the public key. The private key and the public key may be generated for each electronic signature by the user terminal 200 and may be valid only for the corresponding electronic signature.

Specifically, the user terminal 200 may hash the signature data generated during the video signature process, electronically sign the hashed digest using the private key, and then transmit the signature data and the electronic signature to the video signature generation unit 150. In this case, the video signature generation unit 150 may decrypt the electronic signature using a public key, hash the received signature data, and compare the resulting hashed digest with the data (digest) decrypted using the public key for validation.

However, the electronic signature, encryption, and decryption methods of the user terminal 200 and the video signature generation unit 150 are not limited to the description above; any electronic signature, encryption, and decryption methods may be applied as long as the methods ensure user and message authentication and maintain confidentiality.

When the user terminal 200 completes video signature, the video signature generation unit 150 may encrypt the video signature data and store the encrypted video signature data in the data storage unit 190 and generate a video signature ID and video signature information of the corresponding video signature.

The video signature ID is the data used to identify each video signature, where the video signature ID may not be disclosed externally and may be stored in the data storage unit 190 by being mapping to the corresponding video signature data. Also, the video signature ID may be stored after being encrypted. In some embodiments, when the video signature process is completed, the video signature generation unit 150 may receive the face ID generated during the corresponding video signature process from the face ID generation unit 160 to be described later, combine the video signature ID with the face ID, hash the combination, and store the resulting hash.

The video signature information may include, but is not limited to, a contract name, names of signing participants, date of electronic signature, video size (or capacity), and signature. The signature key may be the second public key used to decrypt the electronic signature of the user terminal 200 during the video signing process.

As described above, the video signature generation unit 150 according to one embodiment generates a video signature during a real-time video contract process, records the signing process of the user terminal 200 in real-time, and stores the recordings as a video, thereby allowing contract participants to verify their respective signatures in a video form after the contract is completed and preventing a denial by the participants.

Also, the video signature generation unit 150 firstly receives an electronic signature from the user terminal 200 of a signing participant during the real-time video contract process to verify the reliability of the signature; and secondly combines the video signature ID with a face ID, which is generated during video signature and stored and managed on the blockchain as described later, hashes the combination, and stores the hash result, thereby preventing spoofing that may occur during a remote contract process and enhancing the security and reliability of video signatures.

The face ID generation unit 160 may generate a face ID corresponding to the contract participant of each of a plurality of user terminals 200 in conjunction with the contract management unit 140. The face ID generation unit 160 analyzes the captured video from each of the plurality of user terminals 200, received through the input-output interface module 141 during a real-time video contract process, to generate a face ID for each of a plurality of signing participants.

For example, the face ID generation unit 160 may analyze the user's face in real-time from the video received through the input-output interface module 141 while a video signature is generated at the request of the user terminal 200 and generate a face ID. By using a deep learning model, the face ID generation unit 160 may extract facial features of contract participants captured by the user terminal 200 and perform deep learning analysis.

The face ID generation unit 160 may store a dataset of facial images and sufficiently train a deep learning neural network by applying the dataset thereto. For example, the deep learning model may employ neural network algorithms based on various deep learning models, such as an inception module-based convolutional neural network (CNN), a deep neural network (DNN), a recurrent neural network (RNN), a restricted Boltzmann machine, a deep belief network (DBN), or a deep Q-network.

Also, the face ID generation unit 160 may analyze in real-time the video captured while the user terminal 200 performs video signature and utilize machine learning for training, thereby enhancing recognition accuracy for the user terminal 200 to use the generated face ID at a later time.

The face ID generation unit 160 may issue a non-fungible token (NFT) for the generated face ID on a blockchain and store the token in a blockchain system (not shown). The blockchain system may be a distributed database composed of a plurality of blocks. For example, the face ID generation unit 160 may generate the face ID and store user authentication transactions using the face ID on the blockchain.

Also, the face ID generation unit 160 may store metadata related to the NFT of the face ID. In this case, the face ID generation unit 160 may store the metadata of the NFT for the face ID in the data storage unit 190; however, the present disclosure is not limited to the description above, and the metadata may also be stored on-chain or in an InterPlanetary File System (IPFS). Here, the metadata of the NFT for the face ID may include the video signature ID of video signature in which the face ID is generated, generation time, user information of a contract participant (e.g., user ID, password, and user terminal information of the contract participant), and a document ID (or contract ID) to be described later.

Also, if the contracting participant involved in the video signature accesses an application program, app, and/or website provided by the system 100 using a user ID, the face ID generation unit 160 may store the user ID as metadata of the Face ID.

As described above, the face ID generation unit 160 according to one embodiment generates a face ID of a signing participant during the video signature process and manages the face ID on the blockchain, thereby checking and authenticating the contract participant's identity using an immutable distributed ledger (blockchain) and enabling the contract participant to independently check their face ID information. Accordingly, forgery or tampering of the face ID used for accessing the contract at a later time may be prevented, and contract access history using the face ID may be checked on the distributed ledger. Furthermore, by recognizing the contract participant's face and generating the face ID during the real-time video signature process without requiring a separate face ID generation procedure, the face ID generation unit 160 enhances the convenience of the user terminal 200.

The media conversion unit 170 may convert the contract generated during the real-time video contract process into a document file format. For example, if the real-time video contract process is paused or terminated, or if at least one contract participant delegates their contract authority during the real-time video contract process, the media conversion unit 170 may add the power of attorney document generated through the system 100 to the document file.

The contract may include at least one video signature. In this case, the video signature may be provided as a captured screen, and a hyperlink may be provided to play the video signature file if the user terminal 200 clicks on the video signature.

When converting a contract generated during the real-time video contract process into a document file, the media conversion unit 170 may issue a document ID. Here, the document ID is a unique ID of the corresponding contract and may be stored after being encrypted. The media conversion unit 170 may provide the contract and the document ID to the electronic document management unit 180.

Also, the media conversion unit 170 may generate an identification code for the contract generated during the real-time video contract process and input the identification code into the document file of the contract. The identification code may be an identification code obtained by encrypting the document ID, at least one video signature ID generated during the real-time video contract, and/or the face ID. The identification code may be implemented as a QR code or a barcode.

The electronic document management unit 180 may map the contract in a file format and the document ID to the video ID of at least one video signature ID and at least one face ID generated during the contract process and store them in the data storage unit 190.

In another embodiment, the electronic document management unit 180 may store the contract in the blockchain system in the form of a non-fungible token (NFT) on the blockchain. In this case, the electronic document management unit 180 may store at least one video signature ID, at least one face ID, and/or a user ID related to the contract as metadata for the NFT of the contract.

When any user terminal 200 accesses the system 100 using an application program, an app, and/or a website provided by the system 100 through a user ID or a face ID used in a previous contract, the electronic document management unit 180 may provide the user terminal 200 with a template list that includes at least one contract containing the user ID and/or the face ID as the metadata.

The data storage unit 190 may store data (e.g., user information) generated by other components of the video signature live contract system 100 or received from the user terminal 200. The data storage unit 190 may organize stored data in a structure suitable for efficient processing.

As described above, when the video signature live contract system 100 according to one embodiment provides a real-time video contract service, by recording a real-time video contract process and providing a video signature function and a function of encrypting video signatures and generating a face ID at the time of video signing, spoofing that may occur in a remote contract process may be prevented, and repudiation by contract participants may be further prevented; therefore, reliability and security of a contract may be enhanced compared not only to a remote contract using conventional electronic documents and electronic signatures but also to a face-to-face contract.

Also, in the video signature live contract system 100 according to one embodiment, since video signatures, face IDs, and documents generated during a real-time video contract process may be separately encrypted and/or managed on a blockchain, it may be advantageous in that forgery or tampering of a contract document is prevented, and contract security is enhanced.

FIG. 5 is a flow diagram illustrating a video signature live contract method of a video signature live contract system according to one embodiment of the present disclosure.

Referring to FIGS. 1 to 5, the video signature live contract system 100 may perform user authentication in response to a request from the first user terminal 200_1 S100.

When the first user terminal 200_1 runs an application program or an app provided by the system 100 or accesses the system 100 through a website, the system 100 may request identity authentication data from the first user terminal 200_1.

For example, the identity authentication data may be the user ID and password registered by the first user terminal 200_1 during membership registration for the service provided by the system 100. In another example, if the first user terminal 200_1 has previously conducted a real-time video contract and video signature through the system 100, the identity authentication data may be the face ID of the user possessing the first user terminal 200_1, where the face ID is generated by the face ID generation unit 160 during the video signature process.

When the system 100 receives the identity authentication data from the first user terminal 200_1, the system 100 may consider that the first user terminal 200_1 has requested user authentication. Accordingly, the identity verification unit 120 may perform user authentication based on the data received from the first user terminal 200_1.

The identity verification unit 120 may check whether the identity authentication data received from the first user terminal 200_1 matches previously stored identity authentication data in response to a request from the management unit 110. The previously stored identity authentication data may include the user ID and password registered during membership registration for the service provided by the system 100 and the face ID generated by the face ID generation unit 160.

Subsequently, the system 100 may provide a real-time contract screen to the first user terminal 200_1 S200.

For example, the input-output interface module 141 of the contract management unit 140 may be linked with a plurality of user terminals 200 through an application program, an app, and/or a website provided by the system 100. The input-output interface module 141 may provide a real-time video contract screen to the user terminal 200.

The real-time video contract screen provided by the input-output interface module 141 to the user terminal 200 may include a plurality of user interfaces (UIs). If the user terminal 200 selects (or clicks) any one of the plurality of user interfaces, the input-output interface module 141 may provide the corresponding screen or transmit or request data to or from another component of the system 100 to provide the function. Also, the plurality of user interfaces may include a UI that provides a participant invitation function.

Next, the system 100 may invite at least one contract participant based on a request from the first user terminal 200_1 S300.

The first user terminal 200_1 may request the system 100 to invite a contract participant. For example, the first user terminal 200_1 may request the system 100 to invite a contract participant through the UI that provides the participant invitation function included in the real-time video contract screen.

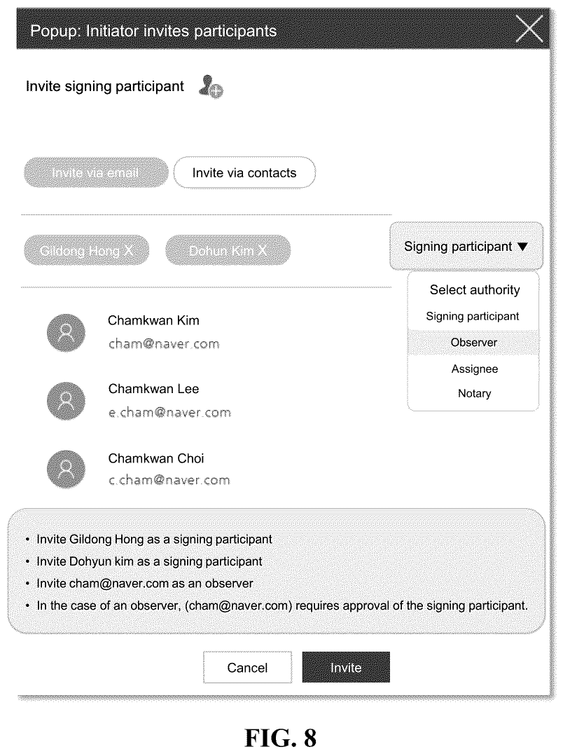

The participant invitation module 142 may provide the first user terminal 200_1 with the contract participant invitation function. Specifically, the participant invitation module 142 may be linked with the input-output interface module 141 to provide the first user terminal 200_1 with a pop-up screen for providing the contract participant invitation function, as shown in FIG. 8. In this case, the participant invitation module 142 may be linked with the contacts, email, and/or messenger application of the user terminal 200 through the input-output interface module 141 to provide the participant invitation function.

The participant invitation module 142 may receive from the first user terminal 200_1 one of the email address or phone number of the contract participant to be invited; and information on the contract participant type (e.g., signing participant, observer, assignee, or notary).

The participant invitation module 142 may send an invitation link to the second user terminal 200_2 to participate in the video signature live contract in response to a request from the first user terminal 200_1. When providing the invitation link to the invited second user terminal 200_2, the participant invitation module 142 may additionally provide information such as the inviter, contract-related information (e.g., the contract name), and the contract participant type, but the provided information is not limited to the specific example above.

Here, the invitation link may be a link that connects to the contract generated by the first user terminal 200_1 invited through an application program, app, and/or website provided by the system 100. The invitation link may be provided in various forms, such as an icon or text.

The participant invitation module 142 may send an email containing the invitation link to the email account of an invited contract participant, send an SMS message containing the invitation link to the second user terminal 200_2 of the invited contract participant, and/or send a message containing the invitation link through the messenger application. Also, if an application program or an app provided by the video signature live contract system 100 is installed on the second user terminal 200_2 of the invited contract participant, the participant invitation module 142 may send a notification pop-up containing the invitation link to the second user terminal 200_2.

Accordingly, at least one contract participant may participate in the real-time video contract provided by the system 100 using the second user terminal 200_2 possessed by the contract participant.

Then, the system 100 may check whether a prior contract exists S400.

The template management unit 130 may check whether a prior contract exists between the user possessing the first user terminal 200_1 and the invited contract participant. Here, the prior contract may be a real-time video contract conducted by the first user terminal 200_1, which has been stored with video recording paused during the second contract session by the owner of the first user terminal 200_1, but the present disclosure is not limited to the specific description.

If no prior contract exists, the system 100 may provide a template list to the first user terminal 200_1 S510. The template list may include various types of contract templates stored and managed by the template management unit 130 and a list of templates pre-generated by the first user terminal 200_1. The pre-generated template list may include contracts generated through the template management unit 130 by the first user terminal 200_1 before proceeding with a real-time video contract.

In this case, the system 100 may receive a selection from the first user terminal 200_1 regarding one of the templates in the list and provide the selected contract template to the plurality of user terminals 200 participating in the real-time video contract.

On the other hand, if a prior contract exists, the system 100 may provide the contract template of the prior contract to the plurality of user terminals 200 participating in the real-time video contract S520.

After that, the system 100 may start and stop the recording of the real-time video contract S600, S700.

For example, the video recording module 145 may record the real-time video contract process in conjunction with the input-output interface module 141. The video recording module 145 may start, pause, and stop video recording according to the request of the user terminal 200 of the contract initiator. The video recording module 145 may record the video recording time excluding video recording pause periods.

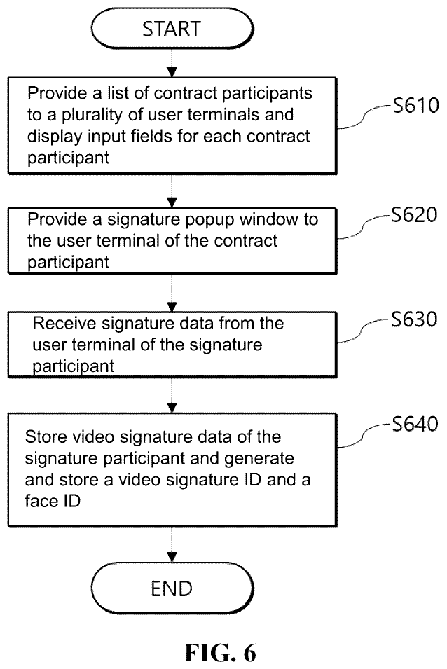

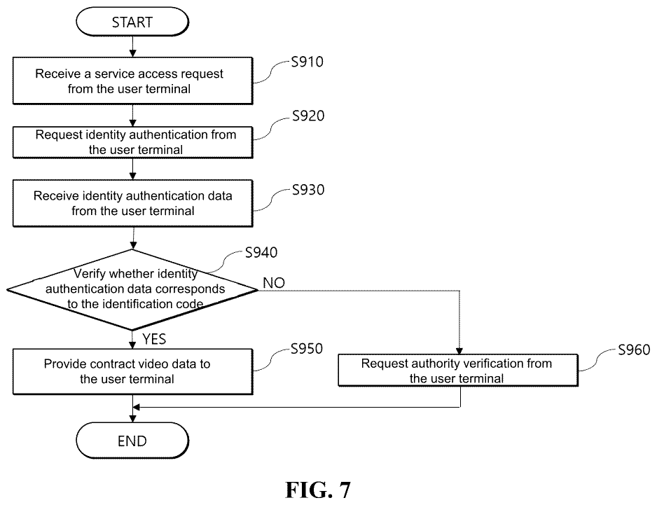

During the recording process of a real-time video contract, the system 100 may provide the real-time video contract and video signature services to a plurality of user terminals 200. The method for providing a real-time video contract and video signature services by the system 100 will be described in detail with reference to FIG. 6.

In FIG. 5, it is assumed that the inviting other contract participants according to a request of the first user terminal 200_1 by the system 100 S300 is conducted before starting the recording of the real-time video contract S600, but the present disclosure is not limited to the specific assumption. For example, the first user terminal 200_1 may invite at least one contract participant through the system 100 between starting the recording of the real-time video contract by the system 100 S600 and stopping the recording of the real-time video contract by the system 100 S700.

Also, the system 100 may generate and manage log data and text data between starting the recording of the real-time video contract S600 and stopping the recording of the real-time video contract S700. Here, the text data may be the data obtained by analyzing voice data received from a plurality of user terminals 200 and converting the analyzed voice data into text during the real-time voice contract.

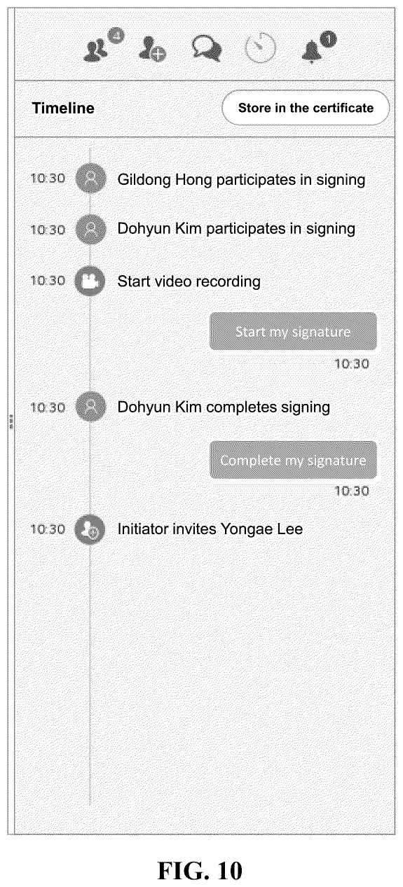

Specifically, as shown in FIG. 10, the log generation module 143 may generate and manage log data for the real-time video contract process, namely, the start (e.g., initiation of video recording), pauses, and completion (e.g., termination of video recording) of the real-time video contract and activity records of each of the plurality of user terminals 200.

Here, the activity records for each of the plurality of user terminal 200 may include time points for invitation, participation, information entry into designated input fields for each participant, initiation and completion of video signature, delegation of authority, approval of delegation, and acceptance of delegation. However, the present disclosure is not limited to the specific example, and the activity records may represent interactions between a plurality of user terminals 200 and the system 100 during the real-time video contract process.

The log generation module 143 may list a real-time video contract process in the chronological order, providing information on the contract process to each of the plurality of user terminals 200 in real-time.

Also, the STT module 146 may interact with the input-output interface module 141 to receive voice data of a plurality of contract participants from a plurality of user terminals 200 during the real-time video contract process and analyze the voice data and convert the analyzed voice data into text. The STT module 146 may distinguish voice data of each of the plurality of contract participants and convert the voice data into text.

The STT module 146 may synchronize the converted text data with the recorded video contract in conjunction with the video recording module 145. In this case, the converted text data may be overlaid on the recorded video contract, but the present disclosure is not limited to the specific implementation. Alternatively, the converted text data may be provided as a separate recorded video alongside the recorded video contract.

In some embodiments, the STT module 146 may generate a document file from the converted text data, and the converted text data may be displayed with the timestamps indicating when the voice data is received from the plurality of user terminals 200.

Finally, the system 100 may store a copy of the contract generated during the real-time video contract process and provide the copy to a plurality of user terminals 200 S800.

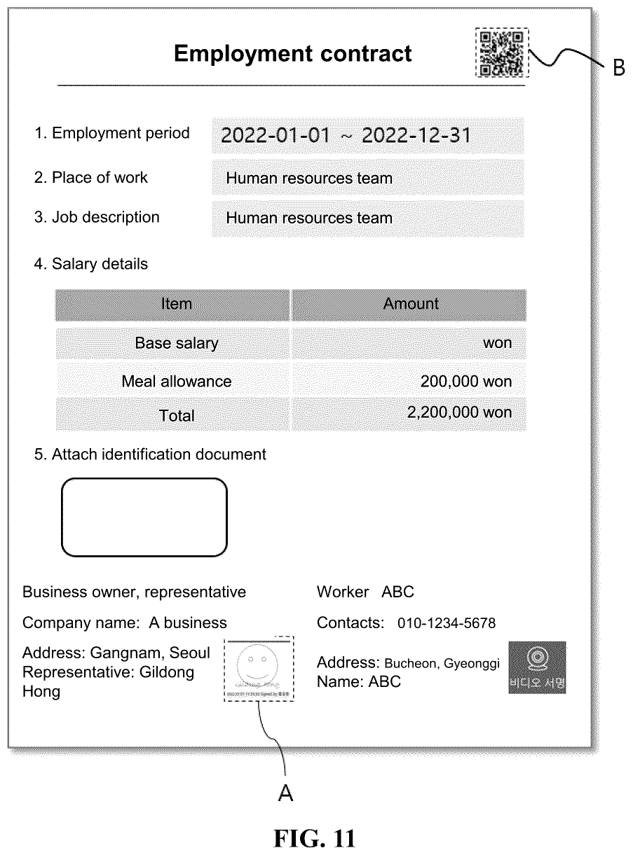

If the real-time video contract process is interrupted or completed, the media conversion unit 170 may convert the contract generated during the real-time video contract into a document file. For example, as illustrated in FIG. 11, the media conversion unit 170 may convert the contract into a PDF file and save the PDF file.

If at least one contract participant has delegated their contract authority during the real-time video contract, the media conversion unit 170 may append the power of attorney document generated through the system 100 to the contract file.

The contract may include at least one video signature. In this case, the video signature may be presented as a captured screen, and when the user terminal 200 clicks on the video signature, the video signature file may be played through a hyperlink.

When converting the contract generated during the real-time video contract into a document file, the media conversion unit 170 may issue a document ID. The document ID serves as identification data for the corresponding contract, which may be encrypted and stored. The media conversion unit 170 may provide the contract and document ID to the electronic document management unit 180.

Also, the media conversion unit 170 may generate an identification code (B in FIG. 11) for the contract generated during the real-time video contract and embed the generated identification code into the document file of the corresponding contract. The identification code may be an identification code obtained by encrypting the document ID and at least one video signature ID and/or face ID generated during the real-time video contract. The identification code may be implemented as a QR code, barcode, and the like.

The electronic document management unit 180 may map the contract file and document ID to at least one video signature ID and at least one face ID generated during the contract and store them in the data storage unit 190.

In another embodiment, the electronic document management unit 180 may store the contract in the form of an NFT on the blockchain system. In this case, the electronic document management unit 180 may store at least one video signature ID, at least one face ID, and/or a user ID related to the contract as the metadata for the NFT of the contract.

Also, if one of the real-time video contracts is completed, the log generation module 143 may manage and store a plurality of log data generated during one of the real-time video contracts to be linked to the recorded video and/or the corresponding contract.

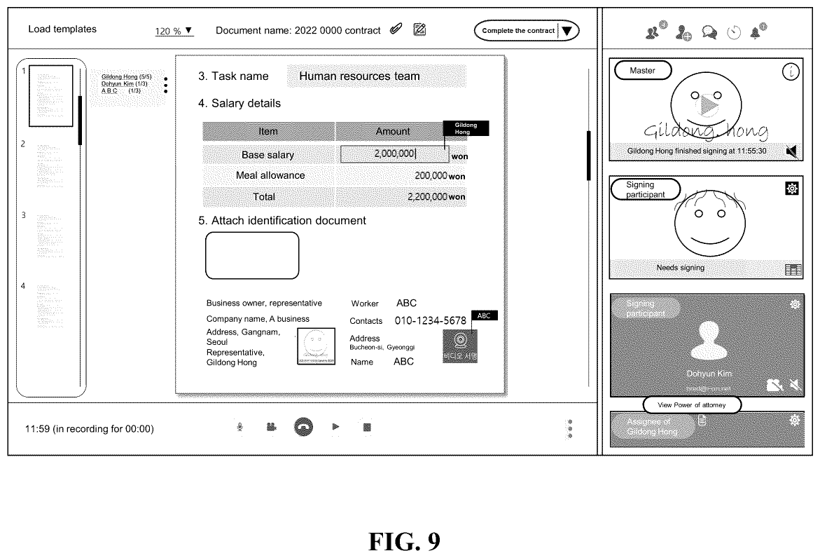

FIG. 6 is a flow diagram illustrating a real-time video contract process of a video signature live contract system and a video signature service provision method according to one embodiment of the present disclosure. FIG. 9 shows a screen in which a video signature live contract system provides a real-time video contract service to a user terminal according to one embodiment of the present disclosure.

Referring to FIGS. 6 and 9, the system 100 may provide a contract participant list PL to a plurality of user terminals 200 and display input fields IF1, IF2 assigned to each contract participant S610.

For example, the template management unit 130 may classify and assign input fields for each contract participant of a contract. Specifically, each contract may include a plurality of input fields that contract participants have to fill in, and the template management unit 130 may classify and assign the input fields that needs to be filled in during the contract based on the participant type information received from the first user terminal 200_1 during the step of inviting at least one contract participant S300.

When providing a plurality of input fields on the contract being drafted to a plurality of user terminals 200 during the contract process, the template management unit 130 may display the classified input fields differently according to the contract participant. For example, when the system 100 displays the contract on each user terminal 200, the template management unit 130 may highlight the input fields assigned to each contract participant who uses their own user terminal 200 differently from other input fields.

Specifically, the template management unit 130 may highlight the input fields assigned to each contract participant by displaying them in a different color from other input fields or by using a box user interface (UI).

In FIG. 9, among a plurality of contract participants in the real-time video contract, the signing participants include “Hong Gil-dong,” who uses the first user terminal 200_1 and “ABC,” who uses the second user terminal 200_2; the template management unit 130 assigns input rights for the first input field IF1 to “Hong Gil-dong” and the second input field IF2 to “ABC.”

As shown in FIG. 9, the template management unit 130 may display information (e.g., name) on a contract participant with input rights on one side of each input field IF1, IF2 in the form of a flag. Accordingly, a plurality of contract participants may use their user terminal 200 to enter data into the input fields assigned to them.

In some embodiments, the template management unit 130 may set the user terminal 200 of a contract participant not to enter data to the input fields other than those assigned to the corresponding contract participant.

Also, the template management unit 130 may generate a list PL of contract participants on one side of the contract document displayed on the user terminal 200 and display both the number of input fields assigned to each contract participant and the number of completed fields along with the list of contract participants. In this case, when the user terminal 200 selects one from the list of contract participants, the template management unit 130 may also provide a function that allows the user terminal 200 to navigate to the input fields assigned to the selected contract participant.

Next, the system 100 may provide a signature pop-up window to the user terminal 200 of a signing participant S620.

When the system 100 receives a video signature request from a user terminal 200 held by any signing participant, the system 100 may provide a signature pop-up window to the corresponding user terminal 200.

Specifically, when a signing participant requests generation of a video signature during a real-time video contract through the user terminal 200, the video signature generation unit 150 may provide the user terminal 200 with a function of generating a video signature using a plurality of data received through the input-output interface module 141. Here, the request for video signature generation by the user terminal 200 may be generated when the user selects a user interface (UI) displayed on the screen through the display module 230 of the user terminal 200, but the present disclosure is not limited to the specific description.

The video signature generation unit 150 may receive the video captured by the camera module 220 of the user terminal 200 through the input-output interface module 141 and record the captured video. Also, the video signature generation unit 150 may provide a signature pop-up window for signing to the user terminal 200 through the input-output interface module 141.

Afterward, the system 100 may receive signature data from the user terminal 200 which has requested the video signature S630.

The signature data may be the data received from the user terminal 200 through the signature popup window. A signing participant may input an electronic handwritten signature or a seal image into the popup window using the user terminal 200 or sign using a public certificate or a private certificate (e.g., KakaoPay authentication, PASS app authentication, or BankSign).

During the process, the video signature generation unit 150 may receive a public key, which forms a pair with a private key used for electronic signing, from the user terminal 200 and authenticate the electronic signature using the public key. The private key and public key are generated for each electronic signature of the user terminal 200 and may form a valid pair only for the corresponding electronic signature.

Specifically, the user terminal 200 may hash the signature data generated during the video signature process, encrypt the hashed digest using the private key, and then transmit the signature data and the electronic signature to the video signature generation unit 150. In this case, the video signature generation unit 150 may decrypt the electronic signature using a public key, hash the received signature data, and compare the resulting hashed digest with the data (digest) decrypted using the public key for validation.

However, the electronic signature and encryption and decryption methods of the user terminal 200 and the video signature generation unit 150 are not limited to the description above; the user and message authentication, such as electronic signature using public and symmetric keys, electronic signature ensuring confidentiality, and encryption and decryption methods may be applied.

Also, when the user terminal 200 signs through the signature pop-up window, the video signature generation unit 150 may receive the signing process in real-time through the input-output interface module 141 and record the signing process so that it is displayed on the video signature screen. Furthermore, when the user terminal 200 completes the signature in the pop-up window, the video signature generation unit 150 may display signature information, which includes the signing participant's name and the time point at which signature is completed, on the video signature screen.

Then, the system 100 may store the video signature data and generate and store the video signature ID and face ID S640.

The face ID generation unit 160 may generate a face ID by analyzing in real-time the video received through the input-output interface module 141 while generating a video signature at the request of the user terminal 200. The face ID generation unit 160 may use a deep learning model to extract facial features of a contract participant captured by the user terminal 200 and perform deep learning analysis.

The face ID generation unit 160 may store a dataset of facial images and sufficiently train a deep learning neural network by applying the dataset thereto. For example, the deep learning model may employ neural network algorithms based on various deep learning models, such as an inception module-based convolutional neural network (CNN), a deep neural network (DNN), a recurrent neural network (RNN), a restricted Boltzmann machine, a deep belief network (DBN), or a deep Q-network.

The face ID generation unit 160 may analyze in real-time the video captured while the user terminal 200 performs video signature and utilize machine learning for training, thereby enhancing recognition accuracy for the user terminal 200 to use the generated face ID at a later time.

The face ID generation unit 160 may issue a non-fungible token (NFT) for the generated face ID on a blockchain and store the token in a blockchain system (not shown). The blockchain system may be a distributed database composed of a plurality of blocks. For example, the face ID generation unit 160 may generate the face ID and store user authentication transactions using the face ID on the blockchain.

Also, the face ID generation unit 160 may store metadata related to the NFT of the face ID. In this case, the face ID generation unit 160 may store the metadata of the NFT for the face ID in the data storage unit 190; however, the present disclosure is not limited to the description above, and the metadata may also be stored on-chain or in an InterPlanetary File System (IPFS). Here, the metadata of the NFT for the face ID may include the video signature ID of video signature in which the face ID is generated, generation time, user information of a contract participant, and a document ID (or contract ID) to be described later.

Also, when the user terminal 200 completes video signature, the video signature generation unit 150 may encrypt the video signature data and store the encrypted video signature data in the data storage unit 190 and generate a video signature ID and video signature information of the corresponding video signature.

The video signature ID is the data used to identify each video signature, where the video signature ID may not be disclosed externally and may be stored in the data storage unit 190 by being mapping to the corresponding video signature data. Also, the video signature ID may be stored after being encrypted.

In some embodiments, when the video signature process is completed, the video signature generation unit 150 may receive the face ID generated during the corresponding video signature process from the face ID generation unit 160, combine the video signature ID with the face ID, hash the combination, and store the resulting hash.

The video signature information may include, but is not limited to, a contract name, names of signing participants, date of electronic signature, video size (or capacity), and signature. The signature key may be the second public key used to decrypt the electronic signature of the user terminal 200 during the video signing process.

As described with reference to FIG. 6, the system 100 may provide a video signature service for each user terminal 200 of the signing participants among the contract participants and may terminate video recording in response to a recording termination request from the first user terminal 200_1 possessed by the contract initiator among the contract participants S700.

As described above, when the video signature live contract system 100 according to one embodiment provides a video signature live contract method and a real-time video contract service, by recording a real-time video contract process and providing a video signature function and a function of encrypting video signatures and generating a face ID at the time of video signing, spoofing that may occur in a remote contract process may be prevented, and repudiation by contract participants may be further prevented; therefore, reliability and security of a contract may be enhanced compared not only to a remote contract using conventional electronic documents and electronic signatures but also to a face-to-face contract.

Also, by firstly receiving an electronic signature from the user terminal 200 of a signing participant during the real-time video contract process to verify the reliability of the signature; and secondly combining the video signature ID with a face ID, which is generated during video signature and stored and managed on the blockchain, hashing the combination, and storing the hash result, spoofing that may occur during a remote contract process may be prevented, and security and reliability of video signatures may be enhanced.

Although not described in detail in FIG. 6, real-time video contract and video signature service providing methods of the video signature live contract system 100 may further include providing a function for delegating authority to a plurality of user terminals 200.

For example, the authority management module 144 may provide a function for delegating authority of a contract participant to the user terminal 200. For example, a contract participant may delegate their contract authority through the authority management module 144. Here, the contract authority may include the right of a contract participant to sign during a real-time video contract and the right of the contract participant to enter data into input fields assigned to the contract participant through the system 100, but the contract authority is not limited to the specific example above.

When receiving a delegation request from the user terminal 200 through the input-output interface module 141, the authority management module 144 may provide a power of attorney form to the requesting user terminal 200. For example, the authority management module 144 may display the power of attorney form in a popup window on the user terminal 200 through the input-output interface module 141, but the present disclosure is not limited to the specific example and may provide the power of attorney form in various other forms.

The power of attorney form may include information on the delegator, such as the contract name and the delegator's signature and contact details, wherein the delegator's signature and information of an appointed representative may be provided through designated input fields. The information on the appointed representative may include, but is not limited to, its name, relationship with the delegator, email address, phone number, and ID card image.

When the user terminal 200 attaches an ID card image of the appointed representative to the power of attorney form, the authority management module 144 may provide the ID card image of the appointed representative to the identity verification unit 120 and request verification of its authenticity.

If receiving a request from the user terminal 200 for the delegator's signature on the power of attorney form (e.g., when the user clicks the signature field of the power of attorney on the user terminal 200), the authority management module 144 may provide an additional signature popup window for signing through the user terminal 200. In this case, the delegator may proceed with a video signature via the user terminal 200, but the present disclosure is not limited to the description above. In some embodiments, the delegator may sign using the user terminal 200 with an electronic handwritten signature (or a drawing-based signature) or authenticate the signature using a public certificate or a private certificate (e.g., KakaoPay authentication, PASS app authentication, or BankSign).

The authority management module 144 may send a delegation approval request to the user terminals 200 of contract participants other than the delegator who has delegated the contract authority. For example, once the delegator completes the power of attorney form, the authority management module 144 may send a delegation approval request to the user terminals 200 of signing participants and the contract initiator, excluding the delegator. The delegation approval request may be provided as a notification popup on the user terminals 200 of the signing participants and the contract initiator, excluding the delegator, but the present disclosure is not limited to the description above.

The authority management module 144 may send a contract invitation request for the assignee to the participant invitation module 142. For example, the authority management module 144 may transmit the phone number or email address entered in the power of attorney form, along with the contract invitation request, to the participant invitation module 142. Accordingly, the participant invitation module 142 may send an email, a message, and/or a notification popup containing the invitation link to the user terminal 200 of the assignee. In this case, the participant invitation module 142 may provide authority delegation information to the assignee's user terminal 200 along with the invitation link. The authority delegation information may include the name of a contract delegated by the delegator, delegated authority, and the delegation date.

In some embodiments, the authority management module 144 may classify the delegator, who has delegated their contract authority, as an observer, but the present disclosure is not limited to the specific embodiment. Also, the authority management module 144 may grant or revoke contract authority for contract participants at the request from the user terminal 200 of the contract initiator.

In this manner, by providing a contract authority delegation function within the system 100 for remote contracts and storing and managing authority delegation information, the authority management module 144 streamlines the otherwise cumbersome delegation verification process among contract participants and facilitates subsequent verification of whether the delegation has been legally executed.

FIG. 7 is a flow diagram illustrating a method for providing a video contract data to a user terminal by a video signature live contract system according to one embodiment of the present disclosure. FIG. 11 shows a screen in which a video signature live contract system converts a contract generated during a real-time video contract process into a document form according to one embodiment of the present disclosure.

Referring to FIG. 7, first, the system 100 may receive a service access request from the user terminal 200 S910.

The document-type contract generated through a real-time video contract (e.g., the contract shown in FIG. 11) may be stored in the user terminal 200 or printed in a physical form. The user terminal 200 may recognize (or scan) the identification code (B in FIG. 11) on the stored or printed contract and access the application program, app, and/or website provided by the system 100.

If the user terminal 200 recognizes the identification code (B in FIG. 11), the system 100 may consider it a service access request from the user terminal 200. Also, the system 100 may receive the identification code (B in FIG. 11) from the user terminal 200, decrypt the corresponding identification code, and identify the corresponding document ID, video signature ID, and/or face ID.

Subsequently, the system 100 may request identity authentication from the user terminal 200 S920 and receive identity authentication data from the user terminal 200 S930.

For example, the system 100 may request identity authentication on the application program, app, and/or website accessed by the user terminal 200 via recognition of the identification code (B in FIG. 11). The identity authentication request to the user terminal 200 by the system 100 may be provided in the form of a pop-up window, but the present disclosure is not limited to the specific example.

The user terminal 200 may transmit identity authentication data to the system 100 in response to the identity authentication request from the system 100. Here, the identity authentication data may be the face ID generated during the real-time video contract process for the corresponding contract.

In another embodiment, the identity authentication data may include the user ID and password registered when the user terminal 200 signed up for the service provided by the system 10, and/or a public certificate or a private certificate used for electronic signature.

Then, the system 100 may verify whether the identity authentication data corresponds to the identification code S940.

Specifically, the identity verification unit 120 may authenticate the user based on the data received from the user terminal 200. For example, the identity verification unit 120 may check whether the data received from the user terminal 200 matches the user information (e.g., the user ID, password, and/or user terminal information of the contract participant) of the user operating the user terminal 200.

Also, the identity verification unit 120 may verify whether the identity authentication data received from the user terminal 200 corresponds to the identification code. For example, the identity verification unit 120 may receive the user's facial image data from the user terminal 200 and determine whether the facial image data matches the face ID stored in association with the identification code.

If the identity authentication data received from the user terminal 200 corresponds to the identity authentication data associated with the identification code, the system 100 may provide the video contract data to the user terminal 200 S950.

For example, the system 100 may provide video contract data of the real-time video contract, recorded in correspondence with the identification code, to the user terminal 200 through the application program, app, and/or website.

If the identity authentication data received from the user terminal 200 does not correspond to the identity authentication data associated with the identification code, the system 100 may request authority verification from the user terminal 200 S960.

For example, the system 100 may send a message in the form of a notification popup to the user terminal 200, informing that access rights to the video contract data recorded in correspondence with the identification code are not allowed. However, the authority verification request from the system 100 to the user terminal 200 may be implemented in various forms.

In this case, in some embodiments, the system 100 may provide a message in various forms, which notifies each user terminal 200 of contract participants who have access rights to the video contract data that an unauthorized user has attempted to access the video contract data.

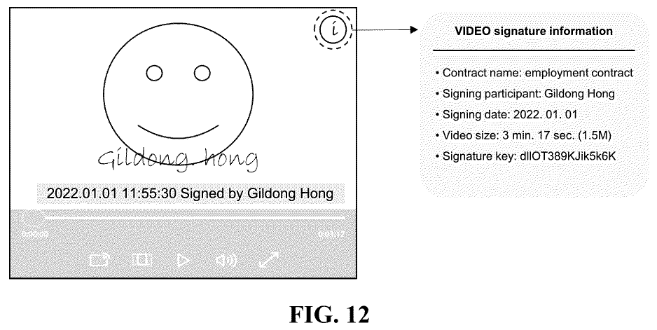

Also, if the user terminal 200 clicks on the video signature area (A in FIG. 11) after accessing the service, the system 100 may provide video signature data to the user terminal 200. For example, the system 100 may present the video signature data in a popup format on the user terminal 200; as shown in FIG. 12, the user terminal 200 may replay the video signature to verify the signing process of the contract participants. Furthermore, the user terminal 200 may check the video signature information along with the video signature data.

So far, the present disclosure has been described in detail with reference to preferred embodiments illustrated in the drawings. These embodiments are not intended to limit the scope of the present disclosure but are merely illustrative and should be considered from a descriptive rather than a restrictive perspective. The true technical scope of protection of the present disclosure should be determined not by the foregoing description but by the technical principles defined in the appended claims. Although specific terms have been used in the present disclosure, they are employed merely for the purpose of describing the concept of the present disclosure and are not aimed to confine the intended use or limit the scope of the present disclosure as set forth in the appended claims. The steps of the present disclosure are not necessarily required to be performed in the specific order described above and may be carried out in parallel, selectively, or individually. It should be understood by those skilled in the art to which the present disclosure belongs that various modifications and other equivalent embodiments of the present disclosure may be made without departing from the essential technical spirit claimed in the appended claims. The equivalents should be understood to include not only currently known equivalents but also any equivalents that may be developed in the future, i.e., all constituting elements designed to perform the same function regardless of their structure.

1. A video signature live contract system comprising:
an identity verification unit that receives an ID card image from a user terminal and verifies authenticity of the ID card;
a contract management unit that provides a real-time video contract screen on the user terminal and records the real-time video contract process;
a video signature generation unit that generates a video signature using the video captured by the user terminal and signature data received from the user terminal; and
a face ID generation unit that generates a face ID using the video captured by the user terminal during the video signature generation process, issues a non-fungible token for the generated face ID, and stores and manages the non-fungible token on a blockchain,
wherein the video signature includes both the video captured by the user terminal and a visual representation of the signature data generation process.

2. The video signature live contract system of claim 1, wherein the video signature generation unit displays signature information that includes the name of a signing participant who generates the signature data and the completion time point of a signature on the video signature screen,
wherein the video signature generation unit generates a video signature ID which serves as identification information for the video signature.

3. The video signature live contract system of claim 1, wherein the video signature generation unit, being linked with the user terminal to perform encryption and decryption processes for the signature data, receives a signature key required for decryption from the user terminal and
generates video signature information for the video signature, wherein the video signature information includes a contract name of the real-time video contract, date of the signature data generation, and the signature key.

4. The video signature live contract system of claim 2, further including a media conversion unit that converts and stores a contract generated during a real-time video contract process into a document file and issues a document ID as the identification information of the contract,
wherein the document ID is stored by being mapped to the video signature ID and the face ID generated during the corresponding real-time video contract process.

5. The video signature live contract system of claim 4, wherein the media conversion unit generates an identification code for the contract and writes the code into the document file,
wherein the identification code is the data obtained by encrypting the document ID, the video signature ID, and the face ID.

6. The video signature live contract system of claim 4, wherein the face ID generation unit stores metadata for the non-fungible token of the face ID,
wherein the metadata includes the video signature ID, the document ID, and user information of a user who owns the user terminal.

7. The video signature live contract system of claim 1, wherein the contract management unit includes a log generation module that generates and manages log data for activities of the user terminal during the real-time video contract process and
a speech-to-text (STT) module that analyzes voice data received from the user terminal during the real-time video contract process and converts the analyzed voice data into text data.

8. A video signature live contract method, in which a system provides a real-time video contract and a video signature service to a plurality of user terminals, the method comprising:
performing user authentication in response to a request from a first user terminal held by a contract participant among the plurality of user terminals by the system;
sending an invitation link to a second user terminal different from the first user terminal in response to a request from the first user terminal by the system;
providing a real-time video contract screen to the plurality of user terminals by the system;
providing a video signature function to at least one of the plurality of user terminals by the system; and
generating a video signature and a face ID for a contract participant carrying the at least one user terminal by the system,
wherein the system generates a video signature using a video captured by the at least one user terminal and signature data received from the at least one user terminal, and
the system analyzes a user's face included in a video captured by the user terminal and generates a face ID.

9. The video signature live contract method of claim 8, wherein the generating of the video signature by the system includes:
displaying signature information, which includes the name of a signing participant who has generated the signature data and a signature completion time point, on the video signature screen and
generating a video signature ID, which serves as identification information for the video signature.

10. The video signature live contract method of claim 9, further including:
receiving a plurality of data, including signature data, from each of the plurality of user terminals and writing a contract by the system;
converting and storing the contract generated during the real-time video contract process into a document file and issuing a document ID by the system, which serves as identification information of the contract; and
storing the document ID by mapping the document ID to the video signature ID and the face ID generated during the real-time video contract process by the system.

11. The video signature live contract method of claim 10, further including:
issuing a non-fungible token for the face ID and storing and managing the token on a blockchain by the system; and
storing metadata related to the non-fungible token of the face ID by the system,
wherein the metadata includes the video signature ID, the document ID, and user information of the user terminal in which the face ID has been generated.

12. The video signature live contract method of claim 8, wherein the providing of the real-time video contract screen to the plurality of user terminals by the system includes:
providing a contract template to the plurality of user terminals by the system; and
displaying a list of a plurality of contract participants along with input fields designated for each participant by the system.

13. The video signature live contract method of claim 8, further including:
generating and managing log data for activities of each of the plurality of user terminals during the real-time video contract process by the system; and
analyzing voice data received from each of the plurality of user terminals during the real-time video contract process and converting the analyzed voice data into text data by the system.

14. The video signature live contract method of claim 8, further including:
recording a real-time video contract process for the plurality of user terminal and generating video contract data; and
providing the video contract data to the at least one of the user terminals by the system.

15. The video signature live contract method of claim 14, wherein the providing of the video contract data to the at least one of the user terminals by the system includes:
receiving identity verification data and an identification code from the at least one of the user terminals by the system; and
verifying whether the received identity verification data corresponds to the identification code.
